(19) United States
(12) Patent Application Publication
(10) Pub. No.: US 2007/0235090 A1
(43) Pub. Date: Oct. 11, 2007

(54) Fluid processing system

(76) Inventor: David Thompson, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 11/401,375

(22) Filed: Apr. 10, 2006

(51) Int. Cl. F17D 1/00

(52) U.S. Cl. 137/574

(57) ABSTRACT

A fluid processing system can include a tank having a peripheral side wall and a bottom defining an interior cavity. An inner chamber can be located within the interior cavity and spaced apart from the peripheral side wall. The inner chamber can have an open bottom in communication with the interior cavity through which fluid within the interior cavity flows thereby reducing the possibility for fluid with entrained air entering into the interior chamber. A flow path into the interior cavity can be tangential to the tank thereby inducing a cyclonic flow pattern around the inner chamber that can cause particles to migrate toward the peripheral wall and the bottom of the tank. The flow path can include a variable height weir that varies with the liquid level in the interior cavity thereby reducing the formation of entrained air in the fluid in the interior cavity.

### FIELD

The present disclosure relates to fluid processing systems that remove particles and entrained air from the fluid flowing therethrough.

### BACKGROUND AND SUMMARY

The statements in this section merely provide background and summary information related to the present disclosure and may not constitute prior art.

Fluids, such as a coolant, can be used to cool, clean and/or lubricate a working tool/piece during a machining operation (e.g., turning, milling, grinding, boring, drilling, etc.). The fluid can be supplied by a pump at a desired pressure and/or flow rate. The used fluid is typically captured for recirculation/re-use. The used fluid can contain particles or debris as a result of a machining operation. The debris can damage the pump(s) used to supply the fluid to the working tool(s). Additionally, the fluid can contain entrained air or gas that can also be detrimental to the pump (e.g., cavitation) and other fluid handling devices used to transport the fluid to the working tools.

In some applications, a central system can be used to remove the contaminants from the used fluid. The central system can use filters to trap the particles. The smaller particles, however, can escape past the filters, and, as a result, the fluid may require further processing to remove the remaining particles. Moreover, the fluid may contain entrained air or gas that needs to be removed. A settling tank can be used to remove additional particles from the fluid and to allow the entrained air to escape from the fluid. The typical settling tank includes a large flat bottom tank into which the fluid is pumped. The fluid remains in the settling tank for a period of time allowing the particles to drop/settle (via gravity) to the bottom of the tank. Additionally, the entrained air or gas can also escape. The fluid is then pumped from the tank and routed to the working tool(s). The size of the settling tank needed to remove the particles can be large and can occupy a significant amount of floor space.

Prior to entering the main area of the settling tank, the fluid can flow into a receiving chamber and encounter a stationary weir. The fluid level builds up in the chamber behind the weir. When the fluid level in the chamber exceeds the height of the weir the fluid flows over the weir and into the main area of the settling tank. Depending on the fluid level in the main area, the fluid may fall over the weir a distance sufficient to entrain additional air within the fluid that can be sent to the working tool(s). Thus, it would be advantageous to have a system that reduces and/or removes these particles from the fluid prior to flowing to the working tool(s). Additionally, it would be advantageous if such a system minimized or eliminated entrained air within the fluid that is being pumped. Moreover, it would be advantageous If such a system has a small foot print.

Over time, the particles that settle out of the fluid in the settling tank can build up and approach the level of the inlet to the pump. This increased level can decrease the effectiveness of the settling tank. As a result, the settling tank is shut down and the contaminant is manually removed from the bottom of the tank. The manual removal is a time consuming and undesirable job. Additionally, the removal process may require that the entire central cooling system be shut down, thereby idling the working tools/stations. Thus, it would be advantageous to be able to remove the contaminants trapped in the settling tank via non-manual means. Additionally, it would be advantageous if such removal process could be easily performed while reducing down time of the equipment.

A fluid processing system according to present disclosure can include a tank having a peripheral side wall, a bottom, and an interior cavity. An inner chamber can be disposed within the interior cavity and can have a peripheral side wall and an open bottom in communication with the interior cavity. The inner chamber peripheral side wall can be spaced apart from the peripheral side wall of the tank such that fluid within the interior cavity can encircle the inner chamber. A fluid flow path can lead into the interior cavity and can be at a higher elevation than the open bottom of the inner chamber. A pump can have an inlet in communication with the inner chamber. Fluid flowing into the interior cavity through the fluid flow path can travel through the interior cavity, enter the inner chamber through the open bottom and can be pumped out of the inner chamber through the pump inlet.

In another aspect of the present disclosure, a fluid processing system can have a fluid flow path that is substantially tangential to the peripheral side wall of the tank. The tangential relationship can allow fluid flowing through the fluid flow path and into the interior cavity of the tank to induce a cyclonic flow pattern around the peripheral side wall of the inner chamber while the fluids enters the inner chamber through the open bottom. The cyclonic flow pattern can inhibit particles within the fluid from entering the inner chamber.

In yet another aspect, a fluid processing system according to the present disclosure can include a variable height weir in the fluid flow path over which a fluid flowing through the fluid flow path travels to reach the interior cavity. A height of the weir can vary with a liquid level in the interior cavity.

The fluid processing system according to the present disclosure can advantageously minimize the creation of entrained air through the use of a variable height weir. The weir can automatically adjust its height so that the fluid flowing thereover and entering into the interior cavity produces little or no entrained air. Additionally, the fluid processing system can advantageously use a cyclonic flow pattern to separate the particles within the fluid. The separated particles can accumulate on the bottom of the interior cavity while the particle free or reduced contaminant fluid flows into the inner chamber to be pumped therefrom. The use of an inner chamber within the interior cavity can advantageously facilitate the settling of the particles out of the fluid and reduce the entrained air within the fluid flowing into the inner chamber. The fluid flow originates from a central portion of the interior cavity and enters into the inner chamber through the open bottom. Within the inner chamber the fluid has additional settling time to allow entrained air to escape and particles to drop therefrom. The tank can have a tapering bottom that funnels the accumulated particles to a central location. The bottom of the tank can be flushed through a flush line to remove the contaminants from within the tank. The contaminants can thereby advantageously be removed without manual cleaning of the tank. Additionally, site gages can be advantageously utilized to visually show the difference between the fluid in the interior cavity and within the inner chamber. Visual comparison can provide an indication of the effectiveness of the fluid processing system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of a coolant processing system according to the present disclosure;

FIG. 2 is a perspective view of a coolant processing system according to the present disclosure with some components removed for clarity;

FIG. 3 is a fragmented perspective view of the coolant processing system of FIG. 2;

FIG. 4 is a top plan view of the coolant processing system of FIG. 2 with the pump and motor removed;

FIG. 5 is a perspective view of the inner chamber of the coolant processing system of FIG. 2;

FIG. 6 is a different perspective view of the coolant processing system of FIG. 2 with the pump and motor removed;

FIG. 7 is a schematic representation of the coolant processing system according to present disclosure within a centralized coolant supply system;

FIG. 8 is a schematic representation of the coolant processing system according to the present disclosure within a stand alone coolant supply system; and

FIG. 9 is a perspective view of another coolant processing system according to the present disclosure.

### DETAILED DESCRIPTION

The following description is merely exemplary in nature and is not intended to limit the present disclosure, application, or uses. It should be understood that throughout the drawings, corresponding reference numerals (e.g., 20, 1020, etc.) indicate like or corresponding parts and features.

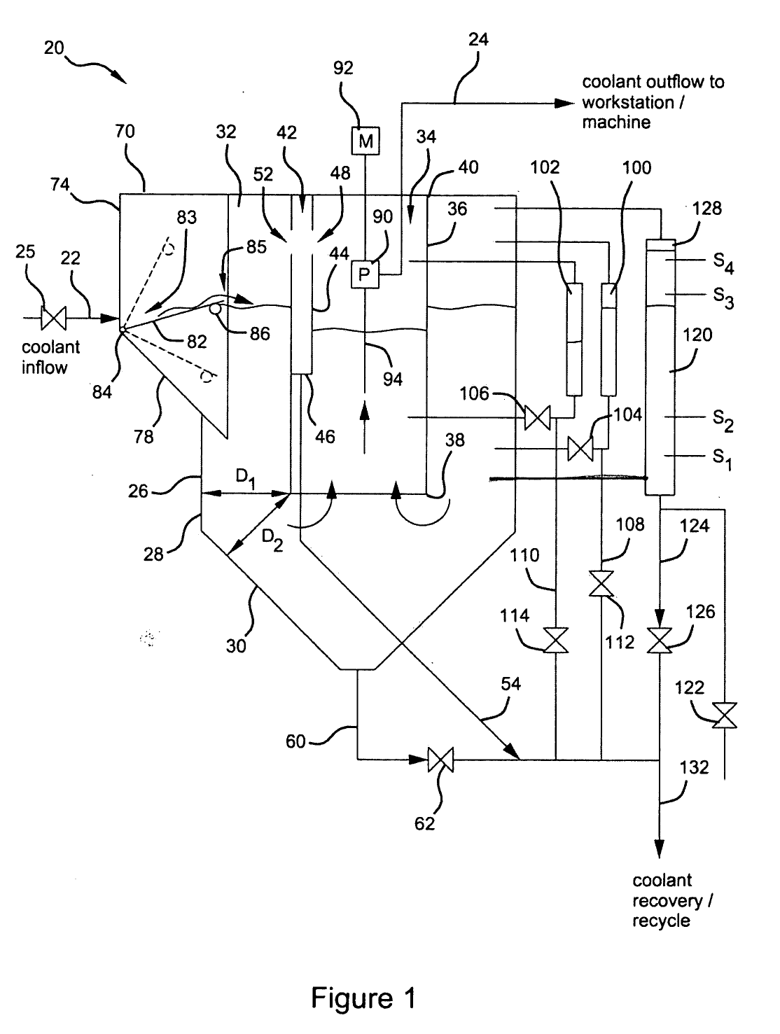

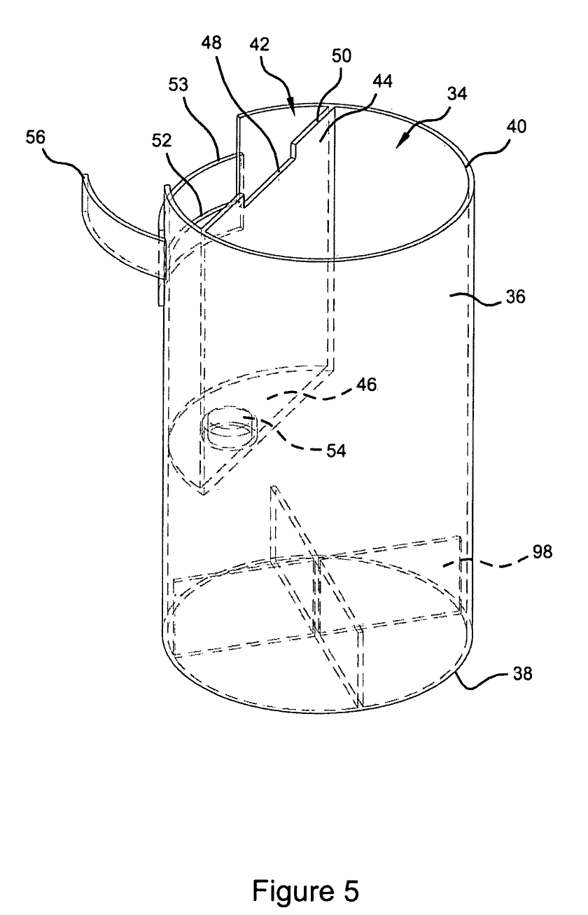

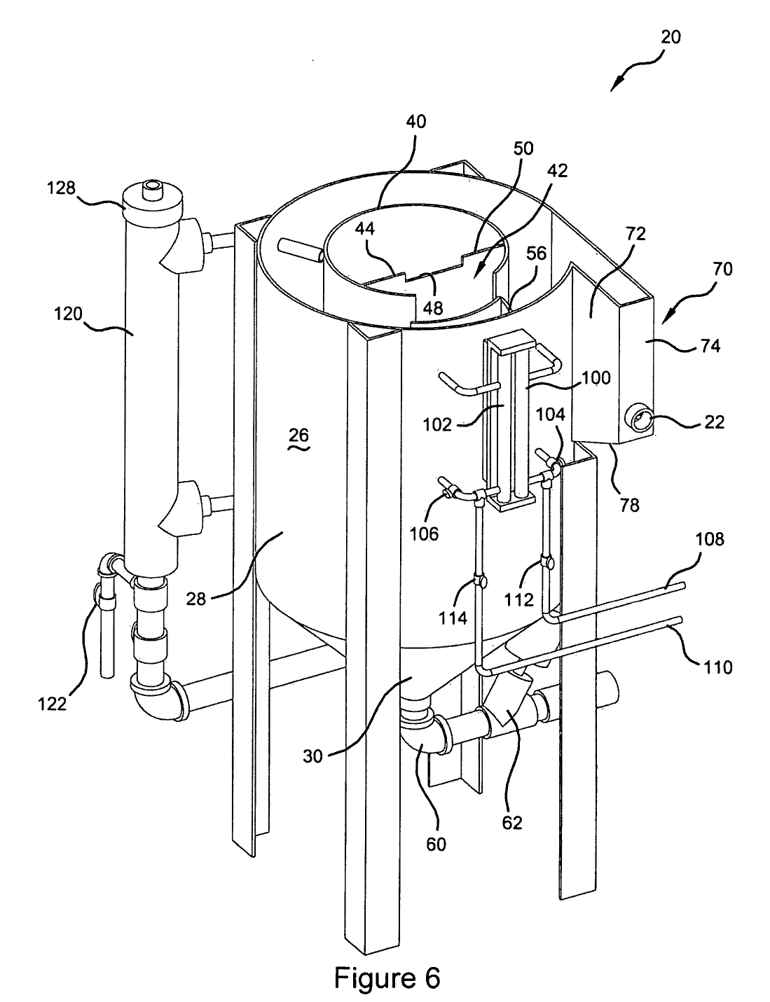

Referring to FIGS. 1-6, a fluid processing system 20 according to the present disclosure is shown. Fluid processing system 20 can be a coolant processing system and can receive a coolant inflow 22, remove particles and entrained air therefrom, and supply a coolant outflow 24 to a downstream workstation or machine. A valve 25 can control the flow of coolant into coolant processing system 20. Coolant processing system 20 can include a tank 26 having a peripheral side wall 28 and a bottom 30 that define an interior cavity 32. Hereinafter, fluid processing system 20 may be referred to as coolant processing system 20. It should be appreciated, however, that fluid processing system 20 can be used to remove particles and entrained air from other types of fluids, although all of the present advantages may not be realized.

Tank 26 can have an inner chamber 34 defined by a vertically extending peripheral side wall 36. A lower edge 38 of peripheral side wall 36 can define an open bottom of inner chamber 34 and a top edge 40 can define an open top of inner chamber 34. Peripheral side wall 36 can be cylindrical, as shown. Alternatively, peripheral side wall 36 can be arranged into other closed configurations, such as square, rectangular, triangular, and the like, although all of the benefits may not be realized.

Inner chamber 34 can be segmented to include an overflow chamber 42. Overflow chamber 42 can include a portion of peripheral side wall 36 and a dividing wall 44 extending across a portion of inner chamber 34 and attached to the interior of peripheral side wall 36. Overflow chamber 42 can include a bottom 46 that seals off the bottom of overflow chamber 42 from inner chamber 34. Dividing wall 44 can include a recessed area 48 along its top edge 50. Recess area 48 can function as an overflow passageway which can allow liquid within inner chamber 34 above the height of recess area 48 to flow into overflow chamber 42. Overflow chamber 42 can also include a recess area 52 along top edge 40 of peripheral side wall 36. A vertically adjustable member/wall piece 53 can be affixed to the exterior of peripheral side wall 36 adjacent recess area 52. The height of member 53 can be set so that liquid within interior cavity 32 above a predetermined height (the height of member 53) flows into overflow chamber 42. An overflow discharge line 54 can communicate with bottom 46 of overflow chamber 42 and can allow liquid within overflow chamber 42 to be drained therefrom, as described below. A scoop 56 can extend from the exterior of peripheral side wall 36 toward the interior of peripheral side wall 28 adjacent recess area 52. Scoop 56 can scoop the top layer of the liquid within interior cavity 32 into overflow chamber 42. For example, scoop 56 can skim foam, bubbles and floating debris into overflow chamber 42, as described below.

Peripheral side wall 28 of tank 26 can be cylindrical, as shown. Alternatively, peripheral side wall 28 can form other closed shapes, such as square, rectangle, triangle and the like, although all of the benefits may not be realized. Bottom 30 of tank 26 can slope or taper inwardly as it extends downwardly from peripheral side wall 28. The tapering of bottom 30 can facilitate the accumulation of particles and debris adjacent a discharge passage 60 that communicates with bottom 30. Discharge passage 60 can include a valve 62 that can be selectively operated to allow liquid and debris within interior cavity 32 of tank 26 to be removed therefrom. Valve 62 can be an automatically controlled valve or a manually operated valve. Bottom 30 can be conical in shape when peripheral side wall 28 is cylindrical. Alternatively, bottom 30 can be pyramidal or include other flat or curved sloping sections.

Peripheral side wall 36 is spaced apart from peripheral side wall 28 within interior cavity 32. The spacing can allow liquid within interior cavity 32 to flow around the exterior of peripheral side wall 36, as described below. Lower edge 38 of peripheral side wall 36 can be spaced apart from the interior surface of peripheral side wall 28 a distance of D₁ in a direction extending perpendicularly from peripheral side wall 28. Lower edge 38 of peripheral side wall 36 can be spaced apart from the interior surface of bottom 30 a distance of D₂ in a direction perpendicular to the surface of bottom 30. Distance D₁ can be equal to or less than distance D₂. Alternatively, distance D₁ can be greater than distance D₂ although all the benefits may not be realized.

Coolant processing system 20 can include an input flow channel 70 that communicates with both coolant inflow 22 and interior cavity 32 of tank 26. Input flow channel 70 can include vertically extending side walls 72, 74, 76 and a bottom wall 78. Bottom 78 can extend downwardly as it extends toward tank 26. A variable height weir 82 can be disposed in input flow channel 70. A height of weir 82 can vary, as shown in phantom in FIG. 1, with the liquid level within interior cavity 32 of tank 26. A first end 83 of weir 82 is pivotally coupled to input flow channel 70 at pivot 84 adjacent coolant inflow 72. First end 83 can be higher than lower edge 38 of peripheral side wall 36. A second end 85 of weir 82 can be coupled to a float 86. Float 86 can cause the elevation of second end 85 of weir 82 to vary with the liquid level in interior cavity 32. That is, as the liquid level in interior cavity 32 varies, float 86 will cause weir 82 to pivot about pivot 84 thereby causing the elevation of second end 85 to vary. Float 86 can be configured so that second end 85 of weir 82 is very close to the liquid level within interior cavity 32, as shown in FIG. 1. As a result, the fluid flowing over weir 82 can experience a minimal change in elevation as it mixes with the fluid within interior cavity 32 thereby reducing and/or eliminating the formation of entrained air.

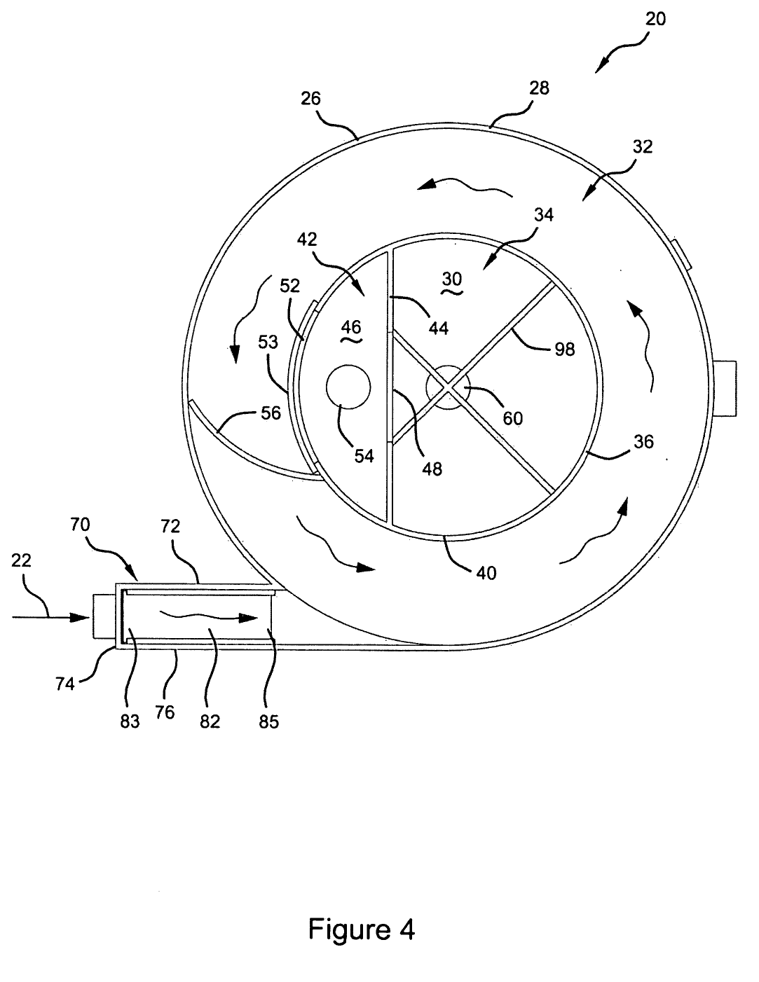

Input flow channel 70 can be tangential to peripheral side wall 28 of tank 26, as shown in FIG. 4. The tangential arrangement can facilitate the coolant flowing into input flow channel 70 over weir 82 inducing a cyclonic flow pattern within interior cavity 32. The cyclonic flow pattern results in liquid within interior cavity 32 flowing entirely around peripheral side wall 36 of inner chamber 34 in a counterclockwise direction, for the configuration shown in FIG. 4. The cyclonic flow pattern can cause particles within the liquid flow to migrate toward the interior surface of peripheral side wall 28 of tank 26. The particles can aggregate along peripheral side wall 28 and sink via gravity to bottom 30 of tank 26.

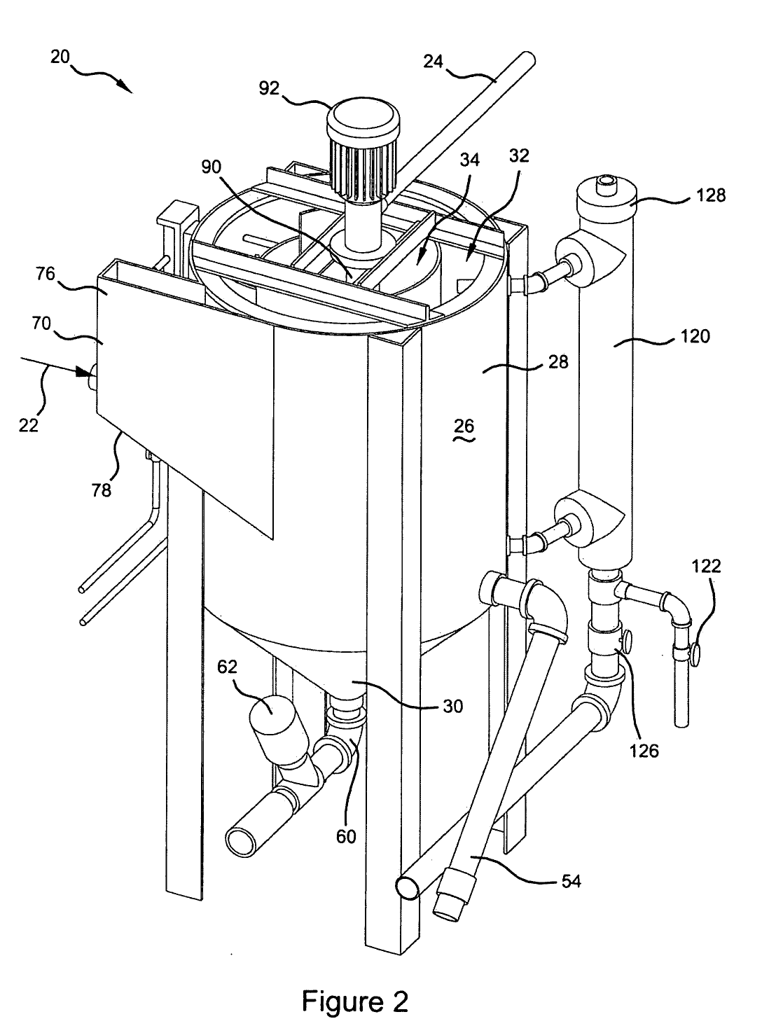

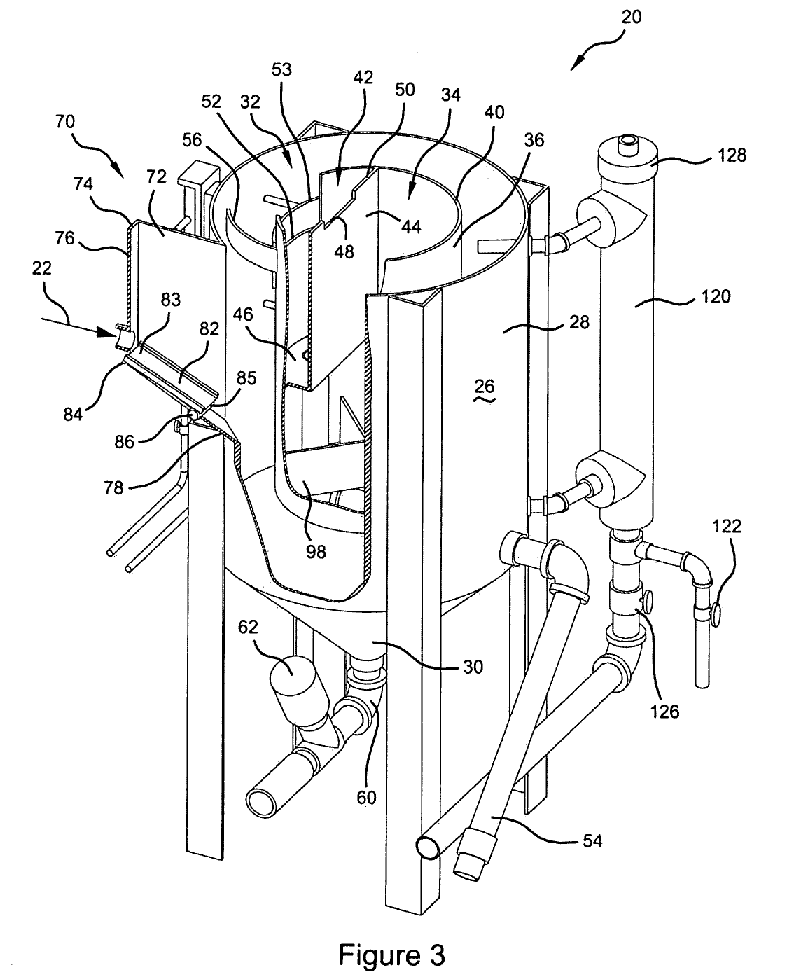

Coolant processing system 20 can include a pump 90 driven by a motor 92, as shown in FIGS. 1 and 2. In the views depicted in FIGS. 3-6, pump 90 and motor 92 are omitted for clarity. It should be appreciated, however, that pump 90 and motor 92 will be present in coolant processing system 20, as indicated as in FIGS. 1 and 2. An inlet passageway 94 of pump 90 can communicate with inner chamber 34. Passageway 94 can be centered within inner chamber 34 such that inlet passageway 94 is substantially aligned with an axial center of inner chamber 34. The central location of inlet passageway 94 can correspond to a neutral zone within inner chamber 34 wherein the liquid therein is at its most calm state. Pump 90 can pump liquid from within inner chamber 34 and produce coolant outflow 24 to supply a coolant flow to a downstream workstation or machine. Pump 90 can be disposed outside and connected via piping or entirely within inner chamber 34, while motor 92 can be external to tank 26, as shown in FIGS. 1 and 2. Disposing of pump 90 at least partially within inner chamber 34 can advantageously capture any fluid leaks from pump 90 within inner chamber 34.

Coolant flowing into coolant processing system 20 enters input flow channel 70 and flows over weir 82 and induces a cyclonic flow pattern within interior cavity 32. The flow circles around peripheral side wall 36 of inner chamber 34 and the particles migrate toward peripheral side wall 28 and bottom 30 of tank 26. As pump 90 extracts liquid from within inner chamber 34, the liquid within interior cavity 32 flows into inner chamber 34 through the open bottom defined by lower edge 38, as indicated by the flow pattern shown in FIG. 1. The liquid flowing into inner chamber 34 comes from the central portion of interior cavity 32 adjacent peripheral side wall 36 and, as a result, does not contain the particles that are pushed outwardly and downwardly due to the cyclonic flow pattern and gravity. Additionally, the liquid entering inner chamber 34 through the bottom is less likely to contain entrained air. Distances D₁ and D₂ can be configured to reduce and/or eliminate turbulence induced in the liquid flowing into inner chamber 34 through the open bottom. That is, by having distance D, equal to or less than distance D₂, the flow going from interior cavity 32 into inner chamber 34 is not restricted or throttled. As a result, the flow into inner chamber 34 can be smooth.

To further smooth the flow into inner chamber 34, baffles 98 can extend across inner chamber 34 adjacent lower edge 38. For example, as shown in FIGS. 3-5, baffles 98 can be configured in a cross or X-shaped pattern. As the liquid flows into inner chamber 34, baffles 98 will reduce and/or eliminate the rotational motion of the liquid and smooth out the flow into inner chamber 34. Baffles 98 can thereby provide a smooth and calm environment within inner chamber 34. The smooth and calm environment can facilitate the elimination of any remaining entrained air from the liquid therein. Additionally, the smoothing of the flow into inner chamber 34 can reduce the possibility of particles entering into inner chamber 34 with the liquid flow therein.

Coolant processing system 20 can include a pair of site gages 100, 102 that allow a visual comparison of the liquid within interior cavity 32 and inner chamber 34. First site gage 100 can communicate with interior cavity 32 such that the liquid within interior cavity 32 flows into first sight gage 100. Second site gage 102 can communicate with inner chamber 34 such that liquid within inner chamber 34 enters into second site gage 102. Site gages 100, 102 can be positioned side by side so that a visual comparison of the liquids therein can be easily ascertained. The liquid within first site gage 100 can include particles and entrained air while second site gage 102 should show a liquid with less particles and less entrained air due to the processing of the liquid by coolant processing system 20. Valves 104, 106 can be used to isolate first and second site gages 100, 102 from the respective interior cavity 32 and inner chamber 34. Discharge lines 108, 110 with respective valves 112, 114 can communicate with gages 100, 102 and with discharge passage 60 downstream of valve 62. Discharge lines 108, 110 can allow the liquid within site gages 100, 102 to be removed therefrom so that new samples can be obtained and compared. Site gages 100, 102 can include a readily visible scale or indicia to facilitate the comparison.

Coolant processing system 20 can include another site gage 120 that can be used to continuously monitor the liquid level in interior cavity 32. Site gage 120 communicates with interior cavity 32 and is coupled to a plurality of sensors S₁, S₂, S₃ and S₄. These sensors can be activated by the liquid level within site gage 120. Sensor S₂ and S₃ can function to maintain the liquid level within interior cavity 32 at a desired level. Sensor S₂ can function as a low level sensor wherein when the liquid level drops to the level of sensor S₂, valve 25 of coolant inflow 22 is commanded to open to allow additional coolant to flow into interior cavity 32. Sensor S₃ can function as a high level shut off wherein sensor S₃ commands valve 25 to close when activated, thereby ceasing coolant inflow into interior cavity 32. As a result, sensors S₂ and S₃ can open and close valve 25 to maintain the liquid level within interior cavity 32 at a desired level. It should be appreciated that in some mechanizations, sensors S₂ and S₃ can activate and deactivate a pump (local or centralized) and/or valve 25 to control the supply of coolant into interior cavity 32. Sensor S₁ can function as a failsafe in the event sensor S₂ fails and/or the supply of coolant in interior cavity 32 falls to a level that activates sensor S₁. Sensor S₁, when activated, can send a signal that is received by the downstream workstation or machine to finish its current job and not to start a new work piece as the coolant supply may be insufficient to continue. Sensor S₄ can act as a failsafe for sensor S₃. In particular, a signal from sensor S₄ can be used to command a shutdown of other components that are operable for the supply of coolant inflow 22 into interior cavity 32. Thus, signals from sensors S₁-S₄ can be used to maintain a desired liquid level within interior cavity 32 and to prevent damage to a workstation due to insufficient coolant flow and to avoid overflowing coolant processing system.

A valve 122 can be used to sample fluid (for test purposes) from interior cavity 32. A discharge line 124 with a valve 126 therein can communicate with site gage 120 and with discharge passage 60 downstream of valve 62. Discharge line 124 can allow the liquid within site gage 120 to be removed therefrom for servicing or cleaning. A cap 128 with attached sensors can be removed from site gage 120 to allow cleaning of site gage 120 and flushing of fluid through valve 126.

Coolant processing system 20 can also utilize additional sensors or gages to monitor the operation thereof. For example, a liquid detection device can be utilized in a catch pan below coolant processing system 20 that can detect the presence of liquid thereon. The liquid detection device can thereby indicate a possible leak in one of the components of coolant processing system 20. Additionally, pressure sensors and/or flow sensors can be utilized with inlet passageway 94, pump 90 and/or coolant outflow 24 to indicate proper operation of pump 90 and the adequate supply of coolant to the downstream workstation/machine.

Discharge passageway 60 can feed into a recycle/recovery line 132. Recovery line 132 can capture the liquid that flows into discharge passage 60 from the various components of coolant processing system 20. Recovery line 132 can route the coolant therein back to a filtering station or processing station for recycling and reuse through the coolant supply system within which coolant processing system 20 is disposed.

In operation, coolant processing system 20 can be operated in a continuous manner with pump 90 providing a continuous coolant flow 24 out of inner chamber 34. Sensors S₂ and S₃ can command the coolant inflow 22 into interior cavity 32 via input flow channel 70. The cyclonic motion of the coolant can cause the particles to migrate to peripheral side wall 28 and bottom 30 of tank 26 while the entrained air is kept away from the open bottom of inner chamber 34. Weir 82 can automatically change its elevation with the elevation change of the liquid within interior cavity 32 thereby reducing and/or eliminating the formation of additional entrained air in the coolant within interior cavity 32. Site gages 100, 102 can be utilized to visually ascertain the performance of coolant processing system 20 throughout its operation. Periodically or as needed, coolant processing system 20 can be operated to cause the quantity of coolant to exceed the overflow level and flow into overflow chamber 42. The intentional overflowing can allow scoop 56 to skim floating debris, foam and other contaminants off of the top layer of coolant therein and route it into overflow chamber 42. Additionally, valve 62 can be opened, periodically or as needed, to allow the debris accumulated within bottom 30 of tank 26 to be flushed therefrom and into a coolant recycle/recovery flow passage 132. During nominal operation, the fluid level within inner chamber 34 can be less than the fluid level in interior cavity 32, as shown in FIG. 1. The difference can be the result of the entrained air within the fluid in interior cavity 32 and/or due to the cyclonic flow pattern of the fluid within interior cavity 32.

Operation of coolant processing system 20 and the various components therein can be performed manually and/or automatically. Additionally, some aspects can be manually operated while others are automatically operated. Coolant processing system 20 can be configured to be controlled by a programmable logic controller, a conventional relay system, or other types of control systems. Additionally, operation of coolant processing system 20 can be performed by a stand alone or dedicated controller or can be performed by a controller controlling operations of the downstream workstation/machine that receives coolant outflow 24 or that controls the operation of the entire coolant supply system of which coolant processing system 20 is merely one component or aspect. Thus, a variety of controllers and control scenarios can be employed to control operation of coolant processing system 20.

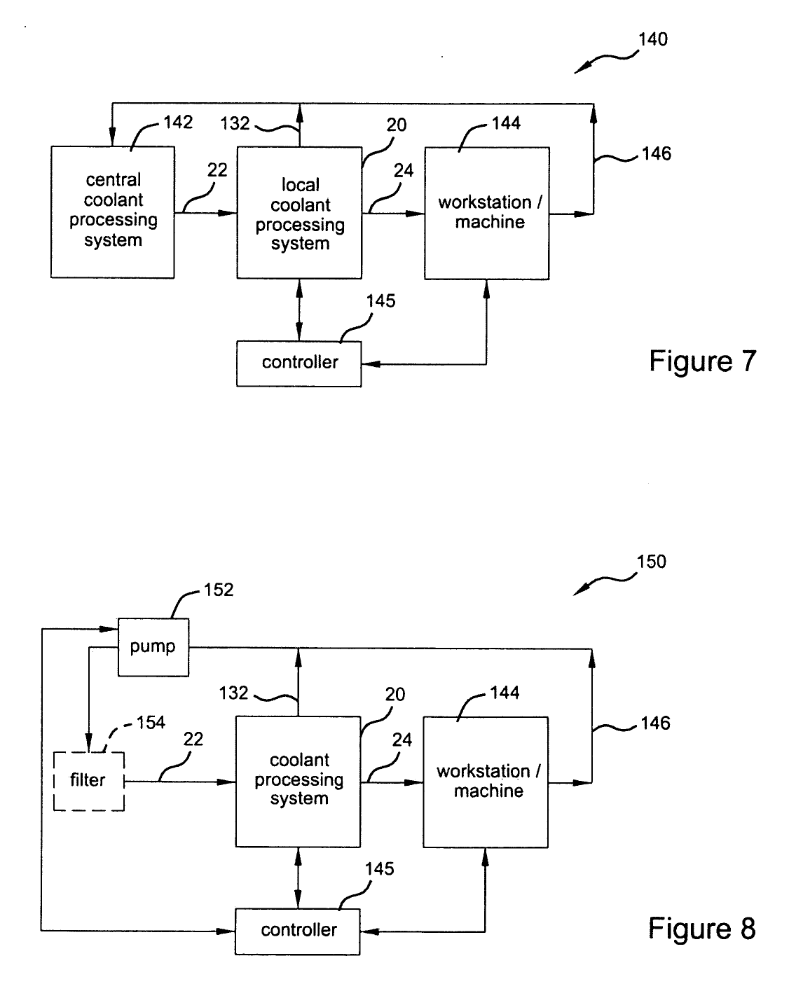

Referring now to FIG. 7, coolant processing system 20 can be utilized as part of a centralized coolant supply system 140. When utilized in this manner, coolant inflow 22 can come from a central coolant processing system 142. In this configuration, coolant processing system 20 operates as a local coolant processing system and supplies coolant outflow 24 to a downstream workstation/machine 144. A controller 145 controlling operation of workstation 144 can be utilized to control operation of coolant processing system 20. Recovered coolant from workstation 144 is routed back to central coolant processing system 142 via a return coolant passageway 146. Coolant recycle passageway 132 can feed into return coolant passageway 146 for return to central coolant processing system 142. Central coolant processing system 142 can filter out particles from the coolant flowing therethrough thereby providing a coolant inflow 22 that has had at least some particles removed therefrom. Coolant processing system 20 functions to reduce and/or remove the remaining particles from the coolant flowing therethrough and reduce and/or eliminate entrained air within the coolant. It should be appreciated that within a centralized coolant supply system 140, the coolant outflow 24 from local coolant processing system 20 can be utilized to supply a coolant flow to one or more workstations or machines 144.

Coolant processing system 20 can also be used in a stand alone coolant supply system 150, as shown in FIG. 8. In this configuration, return coolant passageway 146 can route coolant therein to a pump 152 that can supply coolant inflow 22 to coolant processing system 20. Optionally, coolant inflow 22 can pass through a filtration device 154, such as a bag filter, prior to flowing into input flow channel 70. The controller 145 for workstation 144 can control the operation of pump 152 in addition to that of coolant processing system 20.

Thus coolant processing system 20 can be utilized as a local coolant processing system as part of a centralized coolant supply system or as a stand alone coolant supply system. In both applications, coolant processing system 20 keeps entrained air in the coolant away from inner chamber 34 and inlet passageway 94 to pump 90. Coolant processing system 20 can prevent the promotion of entrained air in the coolant within interior cavity 32 by utilizing a moving weir that automatically adjusts to the liquid level within interior cavity 32. The cyclonic motion can cause the particles within the coolant to migrate away from inner chamber 34 thereby reducing the particles in the coolant in inner chamber 34. Additionally, coolant processing system 20 can utilize site gages to provide a visual indication of the operational performance of coolant processing system 20. Furthermore, coolant processing system 20 can be cleaned through periodic flushing. The sloped or tapering bottom 30 of tank 26 can facilitate the removal of the contaminants through discharge passageway 60.

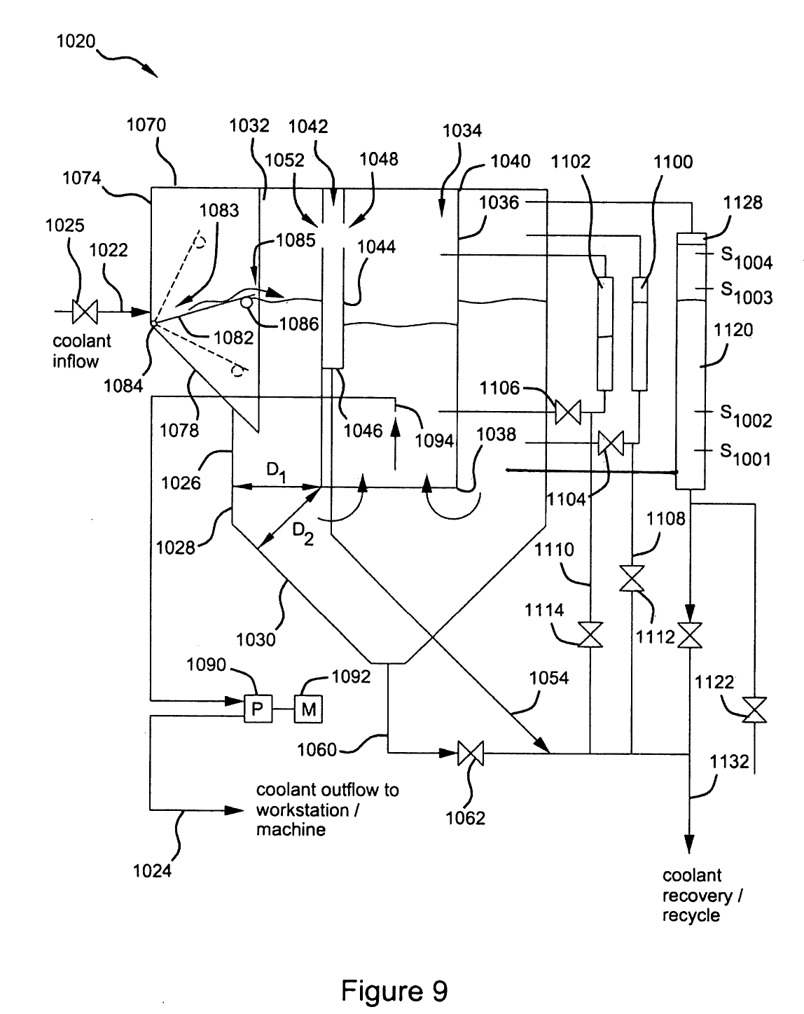

Refer now to FIG. 9, a coolant processing system 1020 according to the present teachings is shown. Coolant processing system 1020 is substantially the same as coolant processing system 20 with the major difference being the location of pump 1090 and motor 1092. In this configuration, pump 1090 is external to tank 1026 along with motor 1092. Inlet passageway 1094 of pump 1090 is still located in the neutral zone of inner chamber 1034. Thus, in the coolant processing system according to the present teachings the pump can be entirely or partially disposed within the inner chamber or entirely disposed outside of the tank.

While the present disclosure has been discussed with reference to specific components and configurations, it should be appreciated that variations in the arrangements discussed can be employed without varying from the scope of present disclosure. For example, while sensors S₁-S₄ are shown as being utilized in conjunction with a site gage, the sensors can be employed the tank. Additionally, while the moving weir is shown pivoting about one end, it should be appreciated that the moving weir can take on other forms. Moreover, fluids other than coolants may be processed in the fluid processing system. Accordingly, the description is merely exemplar in nature and variations are not to be regarded as a departure from the spirit and scope of the present disclosure.

What is claimed is:

1. A fluid processing system comprising:
a tank having a peripheral side wall, a bottom, and an interior cavity;
an inner chamber within said interior cavity, said inner chamber having a peripheral side wall and an open bottom in communication with said interior cavity, said inner chamber peripheral side wall being spaced apart from said peripheral side wall of said tank such that a fluid within said interior cavity can encircle said inner chamber;
a fluid flow path into said interior cavity, said fluid flow path being at a higher elevation than said open bottom of said inner chamber; and
a pump having an inlet in communication with said inner chamber,
wherein fluid flowing into said interior cavity through said fluid flow path travels through said interior cavity, enters said inner chamber through said open bottom and is pumped out of said inner chamber through said pump inlet.

2. The fluid processing system of claim 1, wherein fluid entering said interior cavity though said fluid flow path induces a cyclonic flow pattern within said interior cavity around said inner chamber and said cyclonic flow pattern causes particles in said fluid to migrate toward said peripheral side wall and said bottom of said tank and inhibits said particles from entering into said inner chamber.

3. The fluid processing system of claim 1, wherein said bottom of said tank tapers inwardly as it extends downwardly from said peripheral side wall and further comprising a fluid flow path from said bottom of said tank to an exterior of said tank.

4. The fluid processing system of claim 3, wherein said bottom of said inner chamber is at a higher elevation than a transition from said peripheral side wall of said tank to said tapering bottom of said tank.

5. The fluid processing system of claim 3, wherein a first distance between said peripheral side wall of said tank to said bottom of said inner chamber in a direction orthogonal to said peripheral side wall of said tank is equal to or less than a second distance between said tapering bottom of said tank to said bottom of said inner chamber in a direction orthogonal to said tapering bottom of said tank.

6. The fluid processing system of claim 1, wherein a fluid level in said interior cavity is higher than a fluid level in said inner chamber during nominal operation.

7. The fluid processing system of claim 1, further comprising an overflow chamber in said interior cavity and a fluid flow path from said overflow chamber to an exterior of said tank, said overflow chamber communicating with said interior cavity such that fluid within said interior cavity higher than a first predetermined level flows into said overflow chamber, and said overflow chamber communicating with said inner chamber such that fluid within said inner chamber higher than a second predetermined level flows into said overflow chamber.

8. The fluid processing system of claim 1, further comprising a baffle in said inner chamber adjacent said bottom, said baffle reducing rotation of fluid flowing from said interior chamber into said inner chamber.

9. The fluid processing system of claim 1, wherein said tank peripheral side wall is substantially cylindrical and said inner chamber is substantially cylindrical.

10. The fluid processing system of claim 1, wherein said pump inlet is substantially aligned with a center axis of said inner chamber.

11. The fluid processing system of claim 1, further comprising:
a first sight gage communicating with said interior cavity such that fluid flowing through said interior cavity is visible in said first sight gage; and
a second sight gage communicating with said inner chamber such that fluid flowing through said inner chamber is visible in said second sight gage,
wherein said first and second sight gages enable a visual comparison of the fluids within said interior cavity and said inner chamber.

12. A fluid processing system comprising:
a tank having a peripheral side wall and an interior cavity;
an inner chamber within said interior cavity, said inner chamber having a peripheral side wall and an open bottom in communication with said interior cavity, said inner chamber peripheral side wall being spaced apart from said peripheral side wall of said tank such that a fluid within said interior cavity can flow around said inner chamber;
a fluid flow path into said interior cavity, said fluid flow path being at a higher elevation than said open bottom of said inner chamber, said fluid flow path being substantially tangential to said peripheral side wall of said tank such that fluid flowing into said interior cavity of said tank induces a cyclonic flow pattern around said peripheral side wall of said inner chamber and enters said inner chamber through said open bottom, said cyclonic flow pattern inhibiting particles within said fluid from entering said inner chamber; and
a pump having an inlet communicating with said inner chamber and operable to pump fluid from said inner chamber to an exterior of said tank.

13. The fluid processing system of claim 12, wherein said peripheral side wall of said tank is substantially cylindrical and said peripheral side wall of said inner chamber is substantially cylindrical.

14. The fluid processing system of claim 12, wherein a bottom portion of said tank tapers inwardly as it extends downwardly from said peripheral side wall of said tank and further comprising a flow path from said bottom portion to an exterior of said tank.

15. The fluid processing system of claim 12, wherein said pump inlet is substantially aligned with a center axis of said inner chamber.

16. The fluid processing system of claim 12, further comprising a baffle within said inner chamber adjacent said open bottom of said inner chamber, said baffle reducing rotation of fluid flowing from said interior chamber into said inner chamber.

17. A fluid processing system comprising:
a tank having a peripheral side wall and an interior cavity;
a fluid flow path into said interior cavity;
a variable height weir in said fluid flow path over which a fluid flowing through said fluid flow path travels to reach said interior cavity, a height of said weir varying with a liquid level in said interior cavity; and
a pump operable to pump fluid from said interior cavity to an exterior of said tank.

18. The fluid processing system of claim 17, further comprising a float coupled to said weir, said float automatically varying said height of said weir with said liquid level in said interior cavity.

19. The fluid processing system of claim 18, wherein said weir includes a chute having a fixed pivot at a first end about which said chute pivots, a second end of said chute is coupled to said float, and a height of said second end of said chute automatically varies with said liquid level in said interior cavity.

20. The fluid processing system of claim 19, wherein said second end of said chute is maintained within a predetermined distance from said liquid level in said interior cavity during nominal operation.

21. The fluid processing system of claim 17, further comprising an inner chamber within said interior cavity and having a peripheral side wall spaced apart from said peripheral side wall of said tank and an open bottom in communication with said interior cavity such that a fluid within said interior cavity can encircle and flow around said inner chamber and enters said inner chamber through said open bottom, and wherein said fluid flow path is at a higher elevation than said open bottom of said inner chamber, an inlet of said pump communicates with said inner chamber and fluid within said inner cavity is pumped out of said inner chamber through said pump inlet.
